(19) United States
(12) Patent Application Publication
(10) Pub. No.: US 2016/0017848 A1
(43) Pub. Date: Jan. 21, 2016

(54) FLUID SWITCHING DEVICE FOR A VALVE HAVING AT LEAST THREE PORTS

(71) Applicant: VALEO SYSTEMES DE CONTROLE MOTEUR, Cergy Saint Christophe (FR)

(72) Inventors: Grégory Hodebourg, Sartrouville (FR); Nicolas Martin, Maisonslafitte (FR)

(73) Assignee: Valeo Systemes de Controle Moteur, Cergy Saint Christophe (FR)

(21) Appl. No.: 14/773,400

(22) PCT Filed: Feb. 27, 2014
(86) PCT No.: PCT/FR2014/050428

§ 371 Date: Sep. 8, 2015

(30) Foreign Application Priority Data
Mar. 13, 2013 (FR) 1352229

(51) Int. Cl. F02M 25/07; F16K 11/052

(52) U.S. Cl. CPC F02M 25/0796; F16K 11/052; F02M 25/0793

(57) ABSTRACT

A fluid switching device (1), in particular for a valve having at least three ports, the device (1) comprising: a flap (10) capable of pivoting between a first position in which it blocks a first port (9) and a second position in which it blocks a second port (11), an actuating member (12, 13, 40) for actuating the flap (10), capable of moving the flap (10) from one blocking position to the other, the device (1) comprising an interface part (18, 25) capable of interacting with the actuating member (12, 13, 40), the device being configured in such a way that this interaction selectively allows the flap (10) to be moved by the actuating member (12, 13, 40) and selectively allows the flap (10) to be held in position, the actuating member (12, 13, 40) comprising a mobile part (12, 13) and defining a guide path guiding the interface part (18, 25) when the flap (10) moves, due to the movement of the mobile part (12, 13).

The invention relates to a fluid switching device for a three-way valve, especially for an engine control valve.

The invention applies especially when the thermal engine is used to propel a vehicle, e.g. a motor vehicle. It may be an engine whose fuel is gasoline or diesel. The valve may be integrated in the air circuit of the thermal engine.

Within the meaning of the invention, the term “thermal engine air circuit” designates the circuit between the intake inlet and the exhaust outlet of the thermal engine. The valve can be placed in the intake circuit, the exhaust circuit, or a recirculating loop through which the exhaust gases re-injected pass on intake (EGR).

We know of a switching device for a three-way valve from US2010/0199957. The switching flap is mounted rotatably between a blocking position of the bypass port and a blocking position of a passageway to a cooler. The movement of this flap and its maintenance in blocking position are performed by two separate mechanisms.

The drawback of this switching device is that it has a complex structure due to the large number of the parts it requires whose assembly is complicated and interactions risky. There is a need for a switching device which is relatively simple, robust and inexpensive.

The invention aims to meet this need.

It does, according to one of its aspects, with a switching device of a fluid, especially for a valve having at least three ports, the device comprising:
a flap pivotable between a first blocking position of a first port and a second blocking position of a second port,
an actuating member of the flap capable of moving the flap from one blocking position to the other,
   the device comprising an interface part capable of interacting with the actuating member, the device being configured in such a way that this interaction selectively allows the flap to be moved by the actuating member and selectively allows the flap to be held in position.

The actuating member may comprise a mobile part and may define a guide path guiding the interface part when the flap moves due to the movement of the mobile part.

The mobile part may be mobile in rotation. The axis of rotation of the mobile part may be parallel to that of the flap.

A movement of the actuating member can thus be transmitted to the flap through the interface part. This movement of the actuating member may be caused by an external actuator, for example a pneumatic, hydraulic or electric actuator. This external actuator may already be designed to move a flap of another valve or another flap of the same valve. Alternatively, the external actuator is dedicated to driving the actuating member.

The flap is, within the meaning of the present application, a switching flap, which means that the flap will close off one port in favor of another port to allow the flow of a fluid, and that it is not a priori intended to regulate a fluid flow in a path.

Thus, the actuating member above can alone play two actuating functions for fully controlling the movement of the flap. As already mentioned, the actuating member can allow the movement of the flap. In addition, the actuating member may, by cooperating with the interface part, hold the flap in position when the latter has reached a desired position, in particular a blocking position.

Thus, a movement of the actuating member may be selectively transmitted to the flap for moving the latter, and selectively not be transmitted to the flap so that the latter is held in position. It is thus not necessary to stop in a more or less abrupt way the movement of the actuating member once the flap is in the desired position. The latter can thus continue moving without this movement having any effect on the position of the flap.

The guide path can be formed by a guide housing arranged inside the mobile part, said guide housing having two opposite lateral edges against which the interface part comes selectively into contact when the flap moves from one to the other of the blocking positions. The guide path may be a groove in the mobile part. This path has the effect of guiding the movement of the interface part and therefore that of the flap. The interface part may include a guiding part, in particular a pin, a ball bearing mounted on a pin, or a lug which is adapted to be received in the guide path.

The guide housing may comprise two segments having a common end.

The flap may be in an intermediate position wherein the first and the second ports are open when the interface part rests at the end common to the two segments of the guide housing, the flap passing through one or other of the blocking positions when the interface part moves in one of said segments to its end, opposite to the common end. In other words, the common end of the two segments forms a zone in which the interface part is received when the flap is in an intermediate position.

The guide path may exert a thrust on the interface part for moving the flap when said guiding part moves along the groove from the position corresponding to the intermediate position of the flap, due to the movement of the mobile part.

The lateral edge of the segment nearest to the other segment may extend radially beyond the other lateral edge of said segment, at each end opposite to the common end of a segment. This allows one of the edges of the guide path to be capable of coming into contact with the interface part when the flap is in the blocking position, in order to cause said interface part to go in the guide path for moving the flap from a blocking position to another. Alternatively, this may allow bringing the interface piece out of the guide path so as to prevent further movement of the flap.

The actuating member may further define a holding path for the interface part to hold the flap in one or the other of the blocking positions.

In other words, holding the flap in one or the other of the blocking positions is done by a path along which the actuating member cooperates with the interface part.

The holding path may comprise a lateral edge defined by a portion of the outer periphery of said mobile part. In other words, the holding path may only include one lateral edge in contact with which the guide element comes when the flap is in one of the blocking positions.

Alternatively, the holding path may be a housing formed inside said mobile part on a portion of the periphery of said mobile part. In other words, the holding path may form a groove inside which the guiding part can be housed when the flap is in one of the blocking positions.

The holding path and the guide path may communicate with at least one common lateral edge. In other words, at least one lateral edge of the holding path extends to a lateral edge of the guide path, and vice versa.

The actuating member may comprise a spring which is constrained to the maximum when the flap is in the intermediate position. The spring can exert a force by means of one of its ends to the guiding part, in particular on the pin or lug. The device applies to the spring the greatest stress when the flap is in the intermediate position.

The spring may be configured to selectively hold the blocking flap in position.

The spring may be a compression spring. Thus, the spring is compressed when said flap is in the intermediate position, said spring expanding as soon as the flap begins rotating to achieve a blocking position of one of said paths. The spring acts as an activation device for facilitating the rotation of the flap. Indeed, as soon as the flap deviates from its intermediate position for opening the two paths, following the rotation of the actuating member, the spring relaxes by favoring said rotation. At the end of travel, the spring keeps the flap in one of the blocking positions to seal said blocking. Thus, the flap moves from an unstable equilibrium position corresponding to the intermediate opening position of the two paths to a stable equilibrium position corresponding to a blocking position.

Alternatively, the spring is a tension spring which is stretched when the switching flap is in the intermediate position, said spring being compressed as soon as the flap begins rotating to achieve a blocking position of one of said paths.

The device may be configured so that interaction between the interface part and the actuating member allows holding the flap in a blocking position only by the spring force, the mobile part thus defining only a guide path without participating in the retention in position of the interface part.

The mobile part may be configured so that the guide path is in contact with the interface part only on a limited angular sector during rotation of the mobile part. Accordingly, the mobile part may continue its rotation even after the flap has reached a blocking position, the guide path thus having no longer any effect on the interface part and therefore on the movement of the flap.

The flap and the interface part may be separate parts rigidly coupled to each other. The flap and the interface part are, for example, separated by a seal preventing the fluid, including gases, which is in contact with the flap, from reaching the interface part and the actuating member. Within the meaning of the present application, two parts are rigidly coupled to each other when there is no degree of freedom between them.

In an exemplary implementation of the invention, the rotating mobile part comprises a cam. This cam is, for example, integrated in a gear coupled to the actuator. According to this example, when the cam forming all or part of the mobile part is moved in rotation by the actuator, a portion of its rotation is transmitted to the flap to move the latter when the guiding part, in particular the pin or lug, moves in the guide path formed in the mobile part, while another portion of the rotation of the cam forming the mobile part is not transmitted to the flap which is then held in position when the interface part is out of the guide path, and when it is either free or received in the holding path.

The guide path may be provided between two separate parts, in which case the holding path is delimited by the outer surface of one of these parts. One of the parts is, for example, the above cam while the other part closes the guide path. The axis of rotation of the mobile part may be parallel to that of the flap.

The invention relates also, according to another of its aspects, to an engine control valve having a switching device as defined above.

The valve may include one input port and two output ports, the flap being pivotable to move from a blocking position of an output port to a blocking position of the other output port.

Alternatively, the valve may comprise two input ports and one output port, the flap being pivotable to move from a blocking position of an input port to a blocking position of the other input port.

The blocking of the port by the flap may be either total, and therefore be fully sealed, or partial by allowing a passage of residual fluid leakage, in particular gas.

The valve may, for example, be used in an EGR loop.

A valve as described above has the advantage, among others, to implement a switching device of the flap that is simple, especially because of the small number of parts involved, and therefore compact. Furthermore, it may offer the advantage of having an actuating member, such as a wheel forming a mobile part, which can continue moving after the flap reaches a blocking position, allowing said actuating member to fill an additional holding function during this additional displacement, the additional displacement possibly being due to the resumption of kinematics on another actuating wheel of the valve.

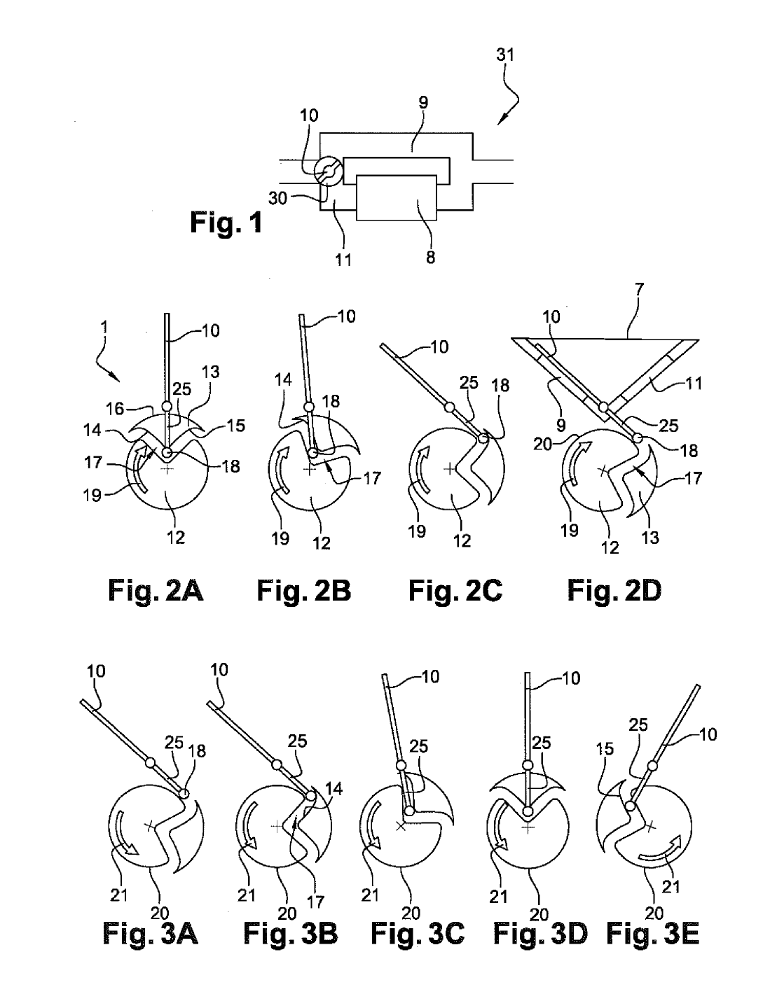

A detailed description of a preferred embodiment of an engine control valve according to the invention is given below, with reference to FIGS. 1 to 4C.

FIG. 1 is a schematic view of an engine control valve comprising a switching device according to the invention,

FIGS. 2A, 28, 2C, and 2D are schematic views of a switching device according to the invention, the switching flap moving from an initial open position of the two paths to a blocking position of one of said paths,

FIGS. 3A, 38, 3C, 3D and 3E are schematic views of the switching device according to FIGS. 2A to 2D, the switching flap moving from its first blocking position to its second blocking position,

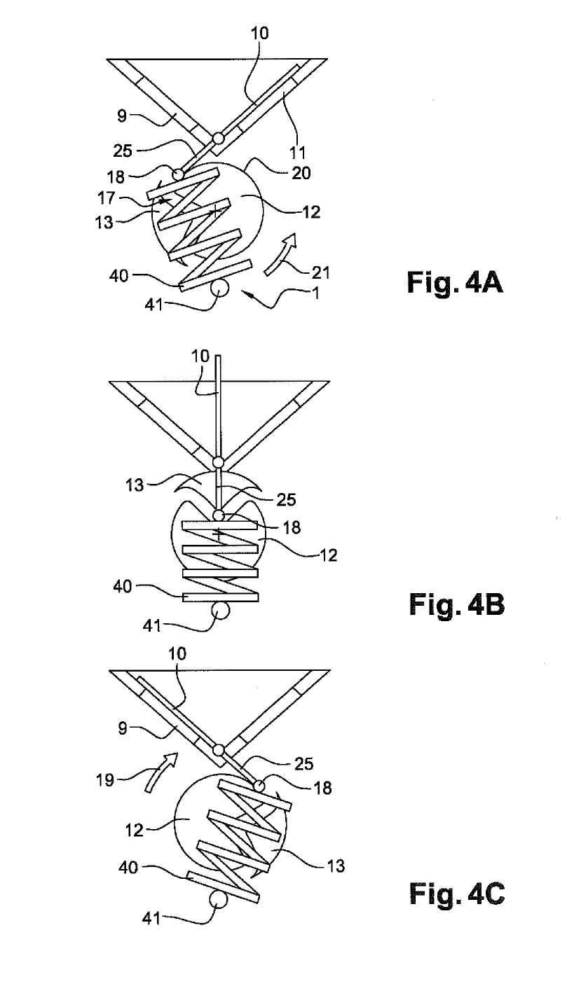

FIGS. 4A, 48 and 4C are schematic views of the switching device according to FIGS. 2A to 3E, the device further comprising a compression spring.

Referring to FIG. 1, a valve 30 is here an engine control valve in which a switching device 1 according to the invention may be integrated.

The engine control valve 30 is placed, for example, in an EGR 31 loop of a thermal engine. The EGR loop 31 includes the valve 30, an EGR gas cooler 8 and a bypass port 9 of said gases originating upstream of said cooler 8 and opening downstream of said cooler 8. The valve 30 comprises a switching flap 10, plane and rotatable, between a first blocking position of the bypass port 9 and a second blocking position of a port 11 for access to the cooler 8.

Referring to FIGS. 2A to 2D, and 3A to 3E, the switching flap 10 for closing the bypass port 9 or the access port 11 to the cooler 8 is rigidly connected to an interface part which is here an actuating crank 25. The actuating crank 25 is, in the example considered, in direct contact with a cylindrical cam 12. This cam 12 has an offset quadrant 13 and is mounted rotatably about its axis of revolution. This cam 12 and quadrant 13 are thus both rotated by an electric actuator (not shown). The quadrant 13 of the cam 12 comprising two diverging rays 14, 15 having a point of intersection and being interconnected by a curved wall 16 shaped in a circular arc, has been moved back relative to the rest of the cam 12 to define a housing 17 substantially V-shaped. This housing 17 comprises two segments having two lateral edges, each of the segments originating in the periphery of the cam 12 and converging toward each other as they enter the cam 12 until they come in communication at their common end. The cam 12 and the quadrant 13 defining the housing 17, constitute a rigidly coupled assembly.

Referring to FIG. 2A, the switching flap 10 is in a median position, opening both the bypass channel 9 and the access port 11 to the cooler 8. This position can be qualified as unstable equilibrium position. Indeed, a compression spring 40, shown in FIGS. 4A to 4C, is mounted between the end 18 of the actuating crank 25 and a fixed point 41. This end 18 plays the role of guiding part of the flap 10. The spring 40 tends to relax and therefore to apply a force on the guiding part 18. This effort tends to drive the actuating crank 25, thus the flap 10, in rotation.

The end 18 may comprise a pin, a lug or a ball bearing mounted on a pin which is inserted into the housing 17, at the end common to both segments. A rotation of the cam 12 in the direction of the arrow 19 causes the rotation of the flap 10. As shown in FIGS. 4C and 4B, this rotation is facilitated by the compression spring 40, which tends to progressively relax as the cam 12 rotates in the direction of the arrow 19, FIG. 4B representing the flap in the position as shown in FIG. 2A, and FIG. 4C representing the flap in the position as shown in FIG. 2D. The arrow 19 shows the direction of rotation of the cam 12 for the flap to switch from the unstable equilibrium position shown in FIG. 4B to the blocking position of the channel 9 shown in FIG. 4C.

Referring to FIG. 2B, when it is necessary to close the bypass channel 9, the actuator rotates the assembly constituted by the cam 12 and the quadrant 13 in the appropriate direction, materialized by the arrow 19. The switching flap 10 begins to pivot through the sliding of the guiding part 18 in a segment of the housing 17, whose orientation was designed to perform this specific rotation of the flap 10. During this movement, the guiding part 18 is driven by contact with the lateral edge of the housing 17 which is opposite to segment 14 of the quadrant 13.

Referring to FIG. 2C, the rotation of the cam 12 and the quadrant 13 continues, accentuating the rotation of the flap 10 towards its blocking position of the bypass channel 9.

Referring to FIG. 2D, the guiding part 18 eventually exits the housing 17 to abut against the outer surface 20 of the cam 12, this exit materializing the blocking position of the bypass channel 9 by the switching flap 10. As indicated by arrow 19 showing the direction of rotation of the cam 12, said cam 12 is not abruptly halted once the flap 10 has reached its blocking position of the port 9, but may instead continue to freely rotate without disturbing the position of the switching flap 10. During this additional rotation phase, the flap 10 is held in its blocking position of the channel 9. Still in this position, as shown in FIG. 4C, the spring 40 keeps the flap 10 in blocking position of the channel 9 by applying a force on the end 18 of the actuating crank 25.

Referring to FIG. 3A, when the switching flap 10 must close the access port 11 to the cooler 8 from its blocking position of the bypass channel 9, the actuator causes the cam 12 and the quadrant 13 to rotate in the opposite direction, as indicated by the arrow 21.

As shown in FIG. 38, the guiding part 18 follows the outer surface 20 of the cam 12 before abutting against the rounded end of the ray 14 of quadrant 13, quadrant 13 which emerges from the cam 12. This rounded end facilitates the drive of the guiding part 18 inside the housing 17.

Referring to FIG. 3C, the guiding part 18 then moves into the housing 17, causing the rotation of said flap 10. During this movement, the guiding part 18 is driven by contact with the lateral edge 14 of the housing 17.

Referring to FIG. 3D, the flap 10 returns temporarily through a median position of said flap 10 to which it opens the bypass port 9 and the access passage 11 to the cooler 8. This position is the unstable equilibrium position such as described above with reference to FIG. 2A.

Referring to FIG. 3D, the flap 10 returns temporarily to a median position of said flap 10 for which it opens the bypass port 9 and the access port 11 to the cooler 8. This position is the unstable equilibrium position described above with reference to FIG. 2A.

Referring to FIG. 3E, the cam 12 continues to rotate in the same direction to gradually bring the flap 10 to a blocking position of the access port 11 to the cooler 8.

Referring to FIG. 4A, the guiding part 18 eventually exits the housing 17 to abut against the outer surface 20 of the cam 12, this exit materializing the blocking position of the port 11 by the switching flap 10. As indicated by arrow 21 showing the direction of rotation of the cam 12, said cam 12 is not abruptly halted once the flap 10 has reached its blocking position of the port 11, but may instead continue to freely rotate without disturbing the position of the switching flap 10. During this additional rotation phase, the flap 10 is held in its blocking position. The compression spring 40 holds the flap 10 in blocking position by applying a force on the guiding part 18.

1. A fluid switching device (1) in particular for a valve having at least 3 ports, the device comprising:
a flap pivotable between a first blocking position of a first port and a second blocking position of a second port;
an actuating member of the flap capable of moving the flap from one to the other of the blocking positions; and
an interface part capable of interacting with the actuating member, the device being configured so that this interaction selectively moves the flap by the actuating member and selectively holds the flap in position,
wherein the actuating member comprises a mobile part that defines a guide path guiding the interface upon movement of the flap by movement of the mobile part.

2. The switching device according to claim 1, wherein the guide path is formed by a guide housing arranged inside the mobile part, said guide housing having two opposing lateral edges against which the interface part selectively comes in contact when the flap moves from one to the other of the blocking positions.

3. The switching device according to claim 2, wherein the guide housing comprises two segments having a common end.

4. The switching device according to claim 3, wherein the flap is in an intermediate position in which the first and the second ports are open when the interface part is received at the common end of the two segments of the guide housing, the flap switching to one or the other of the blocking positions when the interface part moves in one of said segments towards an end opposite to the common end.

5. The device according to claim 3, wherein the device is located at each end opposite to the common end of a segment, the lateral edge of the segment nearest the other segment extending radially beyond the other lateral edge of said segment.

6. The switching device according to claim 1, wherein the actuating member further defines a holding path of the interface part to hold the flap in the one or the other of the blocking positions.

7. The switching device according to claim 6, wherein the holding path has a lateral edge defined by a portion of the outer periphery of said mobile part.

8. The switching device according to claim 6, wherein the holding path is a housing arranged inside said mobile part on part of the periphery of said mobile part.

9. The switching device according to claim 7, wherein the holding path and the guide path communicate through at least one common lateral edge.

10. The switching device according to claim 1, wherein the actuating member has a spring which is compressed to the maximum when the flap is in an intermediate position of opening of the first and second paths.

11. The switching device according to claim 10, wherein the spring is configured to hold the flap in blocking position.

12. The switching device of claim 1, wherein the mobile part is configured so that the guide path is in contact with the interface part only on a limited angular sector during rotation of the mobile part.

13. The switching device of claim 1, wherein the flap and the interface part are separate parts rigidly coupled together.

14. An engine control valve comprising a switching device according to claim 1.

15. The engine control valve according to claim 14, further comprising one input port and two output ports, the flap being pivotable to move from a blocking position of one output port to a blocking position of the other output port.

16. The engine control valve according to claim 14, further comprising two input ports and one output port, the flap being pivotable to move from a blocking position of an input port to a blocking position of the other input port.
